(19) United States
(12) Patent Application Publication
(10) Pub. No.: US 2003/0225738 A1
(43) Pub. Date: Dec. 4, 2003

(54) Graphical user interface for reviewing valuation estimates of perishable resources

(76) Inventors: Chris Ternoey, Dallas, TX (US); Diana Jelescu, Dallas, TX (US)

Correspondence Address: Diana C. Jelescu, 5935 Bonnard Drive, Dallas, TX, 75230, US

(21) Appl. No.: 10/391,505

(22) Filed: Mar. 18, 2003

Related U.S. Application Data
(60) Provisional application No. 60/366,718, filed on Mar. 22, 2002.

(51) Int. Cl. G06F 7/00

(52) U.S. Cl. 707/1

(57) ABSTRACT

Graphic displays are generated for illustrating or explaining a calculation of the marginal value of a perishable resource, such as a capacity of seats on a particular date or a capacity of hotel rooms on a particular stay date. A typical pattern of consumption of the resource is determined by averaging historical consumption patterns, such as booking patterns. Various algorithms are then employed to transform the typical pattern into a planned pattern of consumption. The typical pattern and the planned pattern are then displayed in a comparative manner to illustrate the calculation of marginal value.

### CROSS-REFERENCE TO RELATED APPLICATIONS

This application claims the benefit under 35 U.S.C. §119 of commonly owned U.S. Provisional Application Serial No. 60/366,718 entitled “Graphical User Interface for Reviewing and Editing Valuation Estimates of Perishable Capacity,” filed on Mar. 22, 2002, which is incorporated herein by reference.

### BACKGROUND OF THE INVENTION

This invention relates to the practice of revenue management, which is the process of dynamically adjusting prices of goods or services in response to changes in market conditions or changes in supply conditions. Revenue management processes were pioneered by the passenger airline industry and have been imitated by other industries such as cargo airlines, hotels, rentals, shippers, advertisement brokers and others.

Service providers such as airlines, hotels, rentals, shippers, and advertisement brokers have a need to estimate the marginal values of perishable resources. The marginal value of a perishable resource is defined as the amount of additional benefit or revenue that a service provider would expect to achieve if they had an additional unit of that capacity at their disposal to sell. Estimation of marginal value is often a critical step in the larger problem of optimally choosing what rates or fares or prices to offer to customers.

The specific perishable resource in consideration might be a set of available seats for a particular airline flight. This seating capacity is considered to be a perishable resource because it will become unusable after the date for the flight has passed. Hotels, rentals, shippers and advertisement brokers as well as other service providers often consider their service capacity in similar terms and have a like desire to estimate the marginal value of such perishable resources.

Unfortunately, the enormity of considerations that can impact a marginal value estimate creates obstacles to effective human oversight of the critical estimation process. Consequently, many revenue systems provide inadequate information displays to the human supervisors who monitor and adjust marginal value estimates. This results in numerous ill-advised adjustments, which may have a detrimental impact on the decisions made by the service provider, such as decisions regarding which prices to make available to customers.

A multitude of processes and methods have been designed to address the problem of estimating the marginal value of a perishable resource. Some of these are described in the following patents and journal articles, which are believed to be relevant to the present invention:

U.S. patents

| | | |
|---|---|---|
| 5,918,209 | June 1999 | Campbell, et al. |
| 5,652,867 | July 1997 | Barlow, et al. |

Journal Articles

Peter P. Belobaba, “Airline Yield Management, An Overview of Seat Inventory Control,” Transportation Science, Vol. 21, (No. 2), p. 63-73, (May, 1987).

P. Belobaba, “Application of a Probabilistic Decision Model to Airline Seat Inventory Control,” Operations Research, Vol. 37, pp. 183-197 (3-4/1989).

Garret J. van Ryzin, “Revenue Management Under Consumer-Behaviour Models of Demand,” IATA Revenue Management and Pricing Conference, Oct. 15, 2002.

A classic method for estimating marginal value is described by Belobaba (1987, 1989). More complex methods are described in U.S. Pat. No. 5,652,867 and U.S. Pat. No. 5,918,209. All of these methods require as input a demand forecast describing the sales potential of the perishable resource. Such demand forecasts can only be derived through additional complex mathematical processes that further complicate the control logic of the system.

These and many other examples illustrate that existing methods of estimating marginal value are have vast logical complexity, involving a multitude of formulas that are not easily understood by the typical supervisor of a revenue management system. Consequently, conventional methods of illustrating or explaining a calculation of marginal value of a perishable resource are generally limited in application to real markets as follows:

(a) they do not adequately display the primary factors that form the basis of the marginal value estimate;

(b) they illustrate the calculation in discrete steps, which deprives the end-user of the preferable experience of reviewing all relevant considerations at once; and

(c) they incorporate estimates of intangible or hypothesized entities such as demand levels, which are never directly observed by end-users and thus not easily comprehended by them.

### SUMMARY OF THE INVENTION

In view of the foregoing, a need exists for a method of displaying or explaining a calculation of marginal value of a perishable resource in a manner that is both comprehensive and comprehensible to typical end-users. The present invention represents a method of generating on-screen graphics, which are displayed to the end-user to benefit his judgment about the accuracy of a particular valuation estimate. This display method also aims to raise the end-user's understanding of the factors underlying a marginal value estimate and to enable the end-user to more effectively edit and override existing valuation estimates.

A typical embodiment of the invention displays a graphical user interface (or “GUI”), that presents a range of alternative dates for the user to select and a range of alternative capacity types (e.g. flight numbers) for the user to select and these selection choices collectively determine the specific perishable capacity whose valuation estimate will be studied and/or modified. The GUI also contains a chart graphic that illustrates several patterns of capacity consumption, which constitute the motivation for the current estimate. The GUI also contains buttons and other manual controls that may be used to alter the patterns displayed and/or the valuation estimate.

The computerized graphic displays a time-horizon, which begins with the current period of time and ends with the period when the specified capacity will perish. The computerized graphic displays two patterns of consumption, which are referred to herein as (1) the “typical consumption pattern” and (2) the “planned consumption pattern.”

The “typical consumption pattern” represents the pattern of consumption that is typical for this type of capacity during the time-horizon remaining. This pattern might be generated by accessing a database of consumption records (e.g., flight reservations records) and averaging the number of reservations made during the last day before perishing (e.g. bookings made on the day-of-departure for a specified flight). This average could then be taken as the “typical” bookings associated with this type of capacity on the final day before it perishes. Estimating the “typical” bookings for other periods may be done in a like fashion. Other methods besides simple averaging, such as weighted averages and other formulas with similar results, may be employed as an alternative means to generate a “typical consumption pattern.”

Note that the “typical consumption pattern” is similar to a prediction of future bookings, but it does not incorporate certain details such as the amount of capacity remaining to be consumed for the selected perishable capacity. Thus, the “typical consumption pattern,” as it is defined in our design, represents a metric that bears similarity to a bookings prediction with the exception that it is deliberately blind to incorporating the current inventory position of the selected perishable capacity.

The “planned consumption pattern” represents the pattern of consumption that is both adequate in size to exhaust the remaining capacity by the designated perishing time and similar in shape to the “typical consumption pattern.” The “planned consumption pattern” might be generated by magnifying each element of the “typical consumption pattern” by a common scaling factor that is chosen to ensure that the total consumption of the “planned consumption pattern” equals the remaining capacity available. Alternatively, the planned consumption pattern may be generated by prepending a typical consumption pattern with an instantaneous consumption event that is equal in size to the difference between total typical consumption and remaining capacity. The patterns may be displayed in cumulative or incremental form.

It is natural to think of the “planned consumption pattern” as a sell-out plan that incorporates both the amount of capacity that is available for consumption and the pattern of consumption that has been observed historically. We conjecture that the plausibility of the sell-out plan is correlated with the marginal value, which is a central motivation for displaying this pattern as an aid to reviewing or editing the marginal value.

The benefit of generating the patterns we have defined and graphing them in a comparative manner derives from their use in assessing the marginal value of the capacity in question. Specifically, we conjecture that for selection instances where the “planned consumption pattern” is much smaller than the “typical consumption pattern,” there exists a reasonable basis for expecting a higher estimate of marginal value. We also conjecture that for selection instances where the “planned consumption pattern” is much larger than the “typical consumption pattern,” there exists a reasonable basis for expecting a lower estimate of marginal value. Thus the method of generating and displaying patterns in the manner described gives a great benefit by enhancing the end-user's understanding of the basis for a particular marginal value estimate.

End-users who study the displayed patterns and feel there is a basis for altering the marginal-value estimate may do so directly or they may alter the underlying patterns that motivate the estimate. For example, if the end-user knows that a special event will increase demand for the selected capacity, he may increase one or all elements of the “typical bookings pattern” for this capacity, which in turn will automatically trigger an increase in the marginal value estimate.

More elaborate considerations can be incorporated into the method of defining and displaying the consumption patterns. For example, it is possible for the “planned consumption pattern” to be calibrated to achieve a consumption level that incorporates some degree of overbooking that is strategic for the provider's objectives. The exact consumption level used for the “planned consumption pattern” may be calibrated according to estimates that include but are not limited to:

1. the cancellation rate (or return rate) that is expected for reservations (or purchases) of this capacity;

2. the cost of handling situations where total oversales exceed total cancellations; and

3. the risk aversion level of the provider toward situations where total oversales exceed total cancellations.

Such estimates may be generated automatically based on the contents of records in a database or entered and edited directly by the end-user.

### BRIEF DESCRIPTION OF THE DRAWINGS

The features and advantages of the present invention will become apparent from the following detailed description of a preferred embodiment thereof, taken in conjunction with the accompanying drawing figures, in which:

FIG. 1 is a schematic diagram of networked computer system that can be employed to implement the preferred embodiment of the present invention;

FIG. 2 is a flow chart illustrating the logic used in an exemplary application of the preferred embodiment;

FIG. 3 is an example of a control interface for accessing the programmatic logic to generate the illustrative graphic;

FIG. 4A is an example of the illustrative graphic when consumption is displayed in an incremental manner and the planned consumption pattern is computed by scaling the typical consumption pattern;

FIG. 4B is an example of the illustrative graphic when consumption is displayed in a cumulative manner and the planned consumption pattern is computed by scaling the typical consumption pattern;

FIG. 4C is an example of the illustrative graphic when consumption is displayed in an incremental manner and the planned consumption pattern is computed by prepending the typical consumption pattern with an instantaneous consumption event; and

FIG. 4D is an example of the illustrative graphic when consumption is displayed in a cumulative manner and the planned consumption pattern is computed by prepending the typical consumption pattern with an instantaneous consumption event.

### DETAILED DESCRIPTION OF THE INVENTION

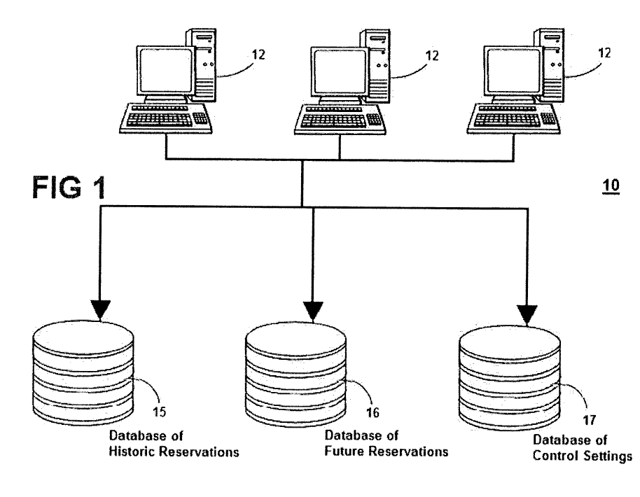

With reference first to FIG. 1, a revenue management system 10 is employed for implementing a first preferred embodiment of the present invention. The system 10 includes a plurality of networked computers 12, each of which communicates with a database 15 of historic reservations and a database 16 of future reservations.

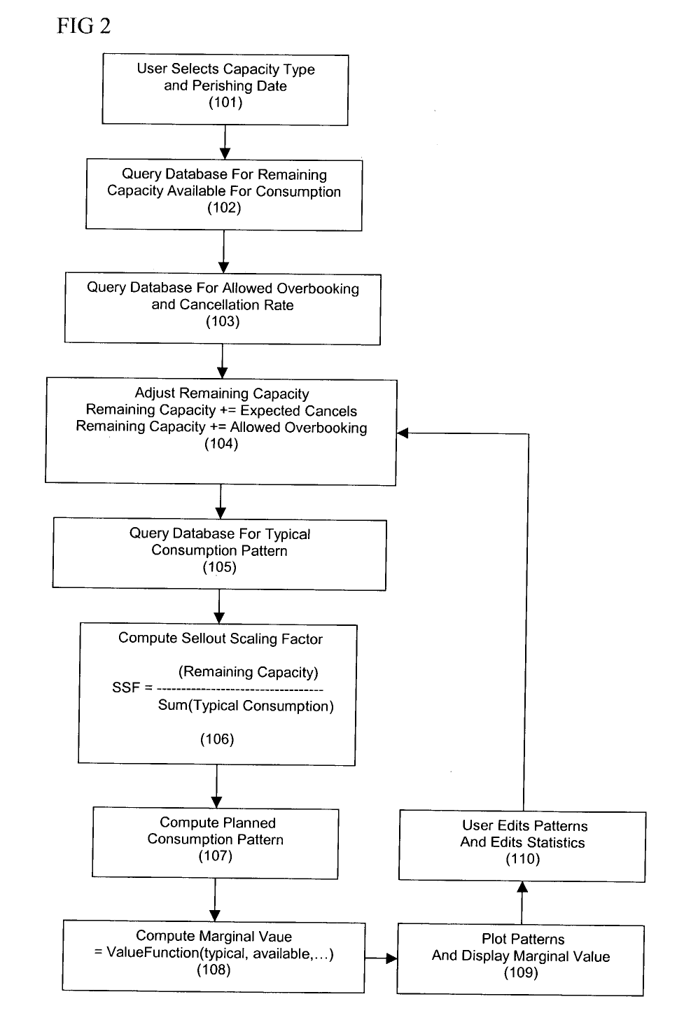

In the operation of the system 10, a system operator enters a request to review a marginal value estimate into one of the computers 12. In response to this request, a programming logic executes, which is detailed in FIG. 2.

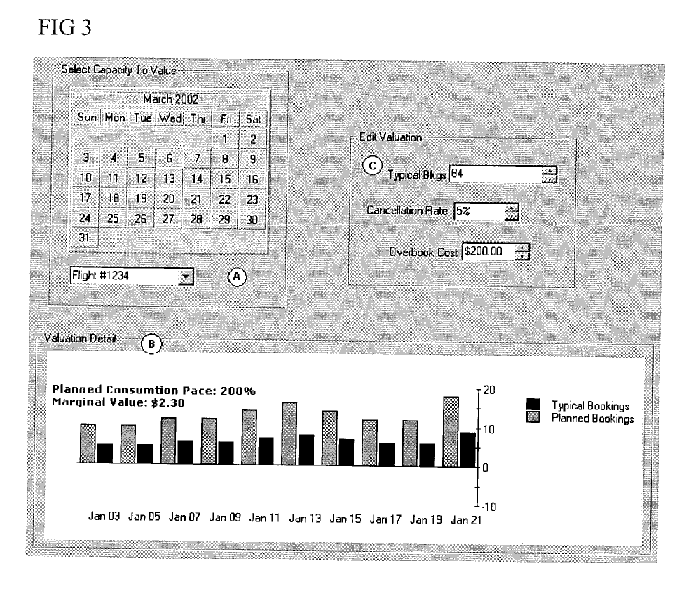

In the first step (step 101), the programming logic presents selection choices to the user for choosing capacity type and perishing date. An example of graphical controls that solicit this choice is shown in control group A of FIG. 3.

In the next step (step 102), the programming logic queries a database 16 of future reservations for the quantity of the selected capacity that is yet unused (e.g., number of seats still available for flight 1234).

In the next step (103), the programming logic queries a database 17 of control settings for the cancellation rate and overbooking level associated with the selected capacity.

In the next step (104), the programming logic adjusts the quantity of unused capacity to incorporate the overbooking allowance that is used for managing the selected capacity. For example the quantity-available would be incremented by 3 units if the airline was comfortable overbooking a flight by three seats. Also, cancellation rate is incorporated by incrementing the available quantity by the expected number of cancellations.

In the next step (105), the programming logic queries a database 16 of historical reservations for the typical consumption pattern of the selected capacity.

In the next step (106), the programming logic computes the sell-out scaling factor, which is the ratio of remaining capacity to typical consumption. For example, a ratio of 2.0 means that capacity must be consumed at twice the typical pace in order to exhaust capacity before the perishing time occurs. Alternatively, the programming logic may compute a sell-out shift factor, which is the difference between the remaining capacity and the typical consumption.

In the next step (107), the programming logic computes the “planned consumption pattern” by scaling the typical consumption pattern according to the sell-out scaling factor (SSF) or by prepending the sellout-scaling factor to the typical consumption pattern.

In the next step (108), the programming logic executes a mathematical formula that estimates the marginal value of the selected capacity based on the typical consumption pattern and the remaining capacity and other attributes of the selected capacity. For example, a designated constant might be multiplied by the reciprocal of the sell-out scaling factor (SSF). Or, a more complex method may be used to achieve a similar result.

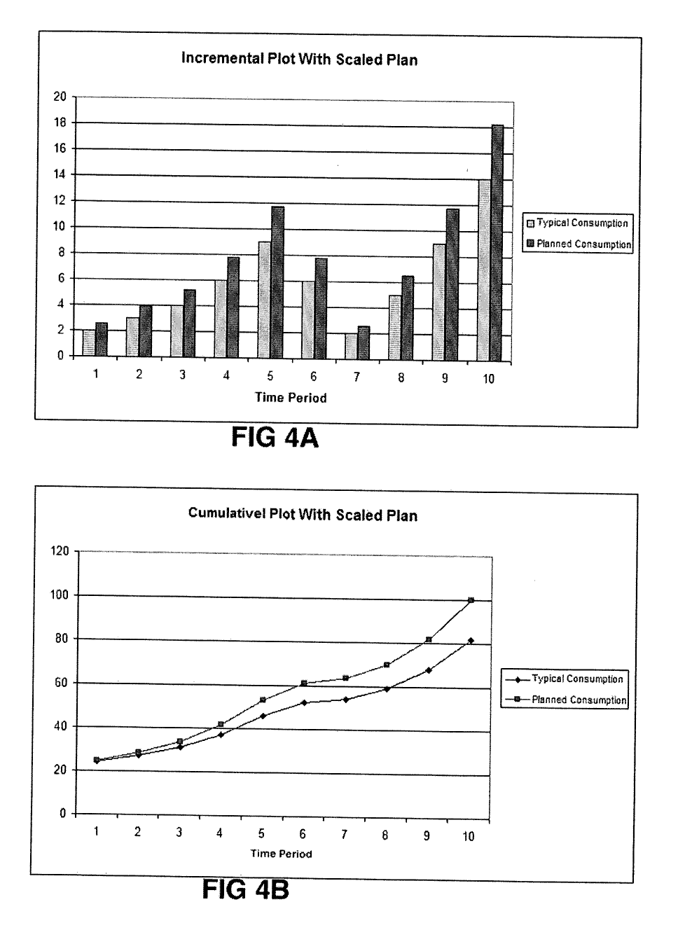

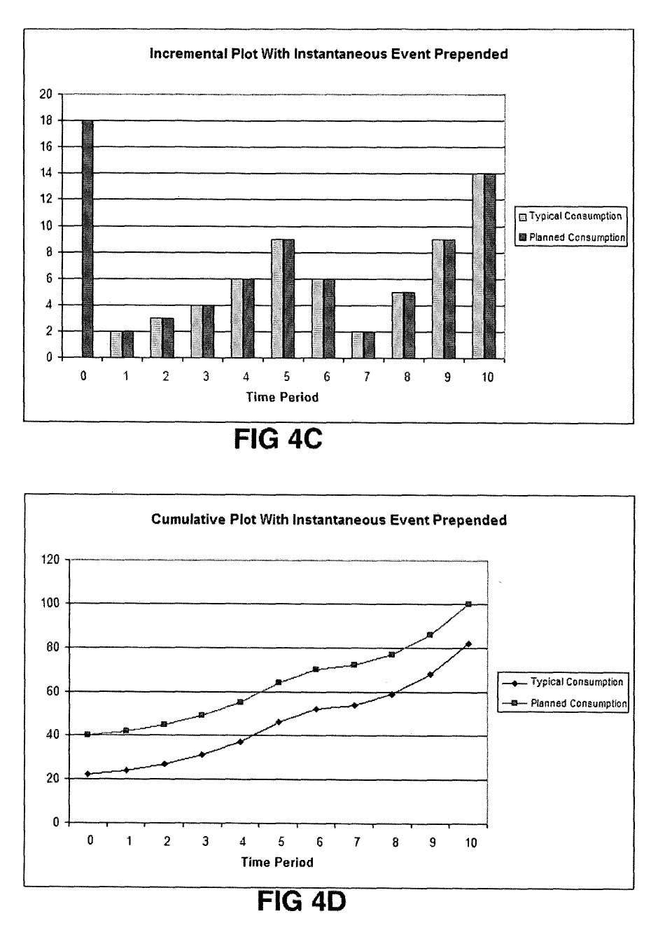

In the next step (109), the programming logic plots the typical consumption pattern and the planned consumption pattern and displays computed statistics and estimated marginal value. An example configuration of this display is shown in control group B of FIG. 3. Alternative configurations of the generated graphic are shown in FIG. 4A, FIG. 4B, FIG. 4C, and FIG. 4D.

In the next step (110), the programming logic solicits user adjustments of the patterns and statistics that are displayed. An example of graphical controls that solicit these edits is shown in control group C of FIG. 3.

In the next step (104), the programming logic re-adjusts the remaining capacity based on the user's edits of the displayed patterns and statistics. This begins the cyclical process of repeating steps 4 through 10 indefinitely.

In conclusion, the present invention, through the use of a programming logic that computes and displays a consumption pattern that is sufficient for exhausting a perishable resource and furthermore generates a graphic comparison of this planned consumption pattern with a typical pattern of consumption, provides a vastly improved method of illustrating or explaining a calculation of marginal value of a perishable resource in a manner that is both comprehensive and comprehensible to typical end-users.

Although the present invention has been disclosed in terms of a preferred embodiment and variations thereon, it will be understood that numerous additional variations and modifications could be made thereto without departing from the scope of the invention as set forth in the following claims.

We claim:

1. A method of generating graphics to assist a human supervisor of a computerized process for estimating the value of perishable resources comprising the steps:
presenting selection choices to the user for selecting a perishable resource and a future calendar date;
querying a database for the quantity of said selected perishable resource that is associated with said selected calendar date and is yet unconsumed;
querying a database for historic records of consumption times and consumption volumes of said perishable resource;
estimating a typical consumption pattern for said perishable resource on said selected calendar date, wherein said typical consumption pattern includes a set of elements, each element representing a consumption volume of resource consumed and a time of resource consumed;
computing a planned consumption pattern by applying a mathematical transformation to said typical consumption pattern, wherein said planned consumption pattern includes a set of elements, each element representing a volume of resource consumed and a time of resource consumed;
generating a graphic plot of said typical consumption pattern and said planned consumption pattern in a shared graphing region, wherein said graphing region displays consecutive time periods in the horizontal dimension beginning at the present time period and terminating with the time period of said selected calendar date;
displaying a statistical estimate relating to said selected resource and said selected perishing date;
whereby said human supervisor is facilitated in his task of reviewing said statistical estimate relating to said selected perishable resource and said selected calendar date.

2. The method of generating graphics as set forth in claim 1, wherein said statistical estimate represents the marginal value or opportunity cost or exhaustion probability of said perishable resource.

3. The method of generating graphics as set forth in claim 1, including the step:
displaying said typical consumption pattern and said planned consumption pattern in incremental form or in cumulative form in said graphical plot.

4. The method of generating graphics as set forth in claim 1, including the step:
executing said mathematical transformation by multiplying said typical consumption pattern by the quotient of the remaining capacity of said selected resource and the sum of all said elements of said typical consumption pattern.

5. The method of generating graphics as set forth in claim 1, wherein said transformation is executed by:
prepending to said typical consumption pattern a new consumption element wherein said new consumption element represents a volume equal to the difference of the remaining capacity of said selected resource and the sum of all said elements of said typical consumption pattern.
